(19) United States
(12) Patent Application Publication
(10) Pub. No.: US 2012/0157070 A1
(43) Pub. Date: Jun. 21, 2012

(54) SYSTEM AND METHOD TO EXECUTE INSTRUCTIONS ON MOBILE DEVICES

(76) Inventors: Jay Kumar Jain, Indore (IN); Vijay Jain, Indore (IN)

(21) Appl. No.: 13/085,700

(22) Filed: Apr. 13, 2011

(30) Foreign Application Priority Data
Dec. 16, 2010 (IN) 3425/MUM/2010

(51) Int. Cl. H04M 3/00

(52) U.S. Cl. 455/418

(57) ABSTRACT

A method and system for executing instructions on a mobile device is provided. The method may involve the steps of dialing an alphanumeric code on the mobile device, transmitting the alphanumeric code to a server, requesting the server for an instruction corresponding to the alphanumeric code, receiving the instruction from the server, and executing the instruction on the mobile device.

### CROSS-REFERENCE TO RELATED APPLICATION

The present application claims priority under 35 U.S.C. 119(a) to Indian (IN) patent application number 3425/MUM/2010 filed Dec. 16, 2010, entitled Â SYSTEM AND METHOD TO EXECUTE INSTRUCTIONS ON MOBILE DEVICES, which IN patent application is incorporated herein by reference in its entirety.

### BACKGROUND OF THE INVENTION

1. Field of the Invention

The invention generally relates to mobile devices and in particular to system and methods for executing instructions on mobile devices.

2. Description of the Prior Art

Mobile devices, with enhanced features, such as cellular telephones and personal digital assistants (PDAs), are becoming increasingly powerful both in terms of processing power and the ability to provide access to data. These devices may not be able to execute instructions relayed by the user effectively, due to the small size of the keypad and the limited memory resources relative to laptop and desktop computers.

Currently, mobile device users can access information (“mobile content”) on the Internet via a wireless data connection. A Wireless Application Protocol (WAP) browser is the most commonly used interface for viewing mobile content. Due to the nature of most mobile devices, many of which do not have a keyboard input, functions such as executing instructions to navigate or access mobile content, executing instructions to open or close software applications on mobile devices, navigating web pages, opening email, etc. may be extremely cumbersome and time consuming.

Current systems of accessing information via mobile devices rely heavily on using either hardware or software based keypad. As described above, this limited input interface of mobile devices impair the speed of the using the device and usability of the information accessed by a mobile device. To address this problem, voice recognition technology has been developed in efforts to provide instruction execution via spoken commands. The state of the art for voice recognition is plagued with speech pattern recognition shortfalls and disrupted voice recognition dialog from background noise. Currently, voice recognition falls short of providing a viable alternative to the keypad interface of mobile devices.

Although present systems and methods are functional, they may not be sufficiently accurate or otherwise satisfactory. Therefore there exists a need for a system, and methods for faster and improved instruction execution on mobile devices. In this regard, the present invention substantially fulfills this need. In this respect, the methods and systems for displaying advertisement on mobile communication devices according to the present invention substantially departs from the conventional concepts and designs of the prior art, and in doing so provides an apparatus primarily developed for the purpose of displaying advertisement on mobile communication devices.

### SUMMARY OF THE INVENTION

In view of the foregoing disadvantages inherent in the known types of mobile devices now present in the prior art, the present invention provides an improved system and methods for executing instructions on mobile devices, and overcomes the above-mentioned disadvantages and drawbacks of the prior art. As such, the general purpose of the present invention, which will be described subsequently in greater detail, is to provide a new and improved system for executing instructions on mobile devices and method which has all the advantages of the prior art mentioned heretofore and many novel features that result in a mobile device which is not anticipated, rendered obvious, suggested, or even implied by the prior art, either alone or in any combination thereof.

Systems and techniques are provided for executing instructions on a mobile device using alphanumeric codes.

In accordance with one aspect of the invention, a method for executing instructions on a mobile device is provided. The method may involve the steps of dialing an alphanumeric code on the mobile device, transmitting the alphanumeric code to a server, requesting the server for an instruction corresponding to the alphanumeric code, receiving the instruction from the server, and executing the instruction on the mobile device.

In accordance with another aspect of the invention, a method for executing instructions on mobile device is provided. The method may involve steps of dialing an alphanumeric code on the mobile device, an instruction execution application checks for presence of special characters in the dialed alphanumeric code, the instruction execution application transmits the alphanumeric code and mobile device characteristics to an application server when the alphanumeric code contains special characters and is not a restricted number. The application server maps the alphanumeric code to an instruction in an instruction database server; the instruction is then transmitted back to instruction execution application for execution on the mobile device.

In accordance with a further aspect of the invention, a system for executing instructions on a mobile device is provided. The system may include a mobile device having a means for transmitting an alphanumeric code, receiving instructions corresponding to the alphanumeric codes and executing the instructions on the wireless device. The system may also include a server for receiving the alphanumeric code transmitted from the wireless device and transmitting the instruction corresponding to the alphanumeric code. The system may also include a database for storing the alphanumeric code and the corresponding instruction.

In accordance with another aspect of the invention an instruction execution application is provided. The instruction execution application may be capable of checking an alphanumeric code dialed on a mobile device for presence of special characters, transmitting the alphanumeric code to a server, receiving at least one instruction corresponding to the alphanumeric code from the server, and executing the instruction on the mobile device.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

The details of one or more implementations are set forth in the accompanying drawings and the description below. Other features will be apparent from the description and drawings, and from the claims.

### BRIEF DESCRIPTION OF DRAWINGS

The invention will be better understood and objects other than those set forth above will become apparent when consideration is given to the following detailed description thereof. Such description makes reference to the annexed drawings wherein:

FIG. 1 is a block diagram of a system for retrieving data to a mobile device.

FIG. 2 is a flow diagram of a process for retrieving information to a mobile device.

Like reference symbols in the various drawings indicate like elements.

### DETAILED DESCRIPTION

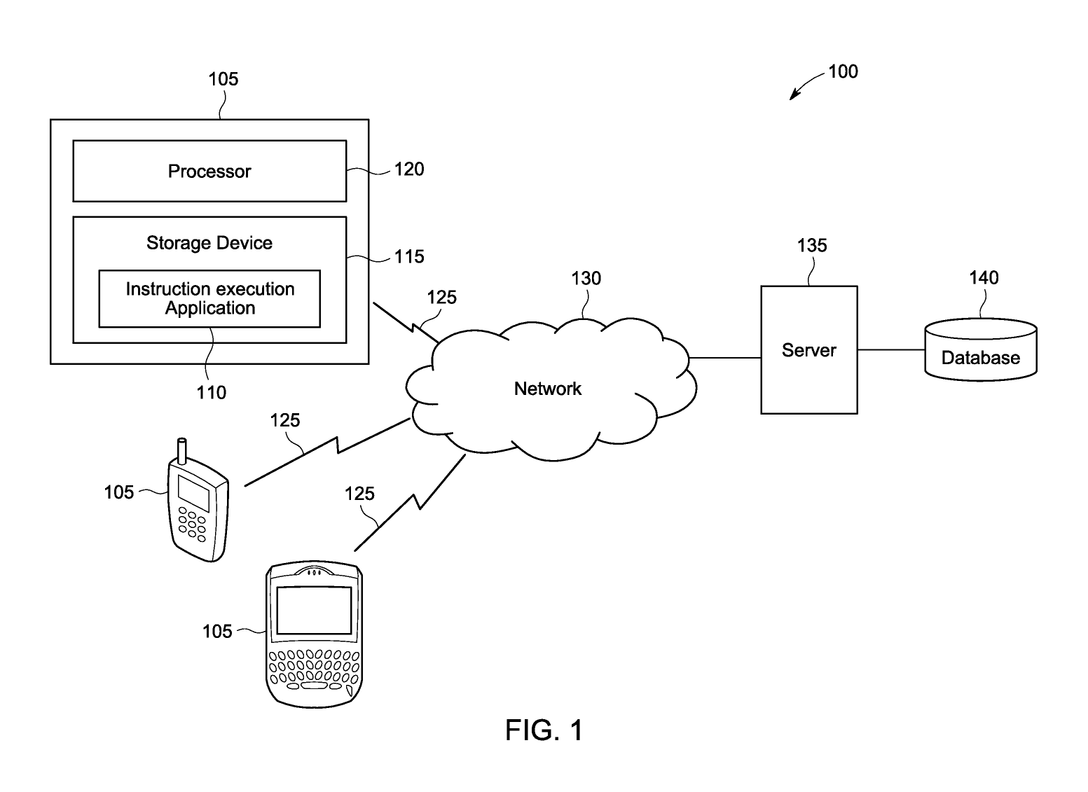

FIG. 1 is a block diagram of a system 100 for executing instruction on a mobile device 105. The mobile device 105 can be a cellular telephone, a PDA, or another type of handheld wireless communications device. The mobile device 105 is capable of executing one or more software applications, displaying information to a user, and receiving user input. The mobile device 105 includes an instruction execution application 110 that is specially designed for use in mobile devices. The instruction execution application 110 is stored in a storage device 115 within the mobile device 105 and executes on a processor 120. The mobile device 105 operates to conduct wireless communications using a cellular, satellite, or other radio communication link 125 over a network 130. The network 130 can include, for example, a public land mobile network, a public switched telephone network, a local area network, a wide area network, and/or any other type of telecommunication network.

The instruction execution application 110 in accordance with aspects of this invention is available to the user before the user initiates instruction execution using the mobile device 105. The instruction execution application 110 may be stored in the mobile device storage device 115 by means of direct downloading via the network from remote servers (not shown). A mobile device manufacturer may preload the instruction execution application 110 on the mobile device 105. The mobile device manufacturer may embed the instruction execution application 110 in the mobile device hardware (not shown).

The instruction execution application 110 executes instructions on the mobile device as per the user's requirement. The instruction execution application 110 connects to the network 130 via the wireless communication capability of the mobile device. The instruction execution application 110 uses the network to communicate with the server 135. The server 135 receives requests from the mobile device 105 via the network 130. In accordance with one aspect of this invention the server 135 receives requests for transmitting instructions corresponding to alphanumeric codes from the mobile device 105 via network 130. The server 135 communicates with database 140 to lookup instructions corresponding to alphanumeric codes.

The instruction execution application 110 may be associated with an application server 135 at a predetermined remote location. The server 135 may be communicated by a predetermined address (e.g., a URL) stored in the instruction execution application 110 or on the mobile device 105. In some embodiments, the predetermined address can change on occasion, such as when the services provided by the application server 135 are moved to a different server. In such situations, it may be possible to update the stored predetermined address. In some implementations, the predetermined address may be associated with a server that assigns another address for handling a request from the instruction execution application 110 (e.g., for purposes of load distribution).

The alphanumeric code, in accordance with aspects of this invention, used to initiate an instruction execution may include a string of numbers, string of numbers and alphabets, string of numbers with special characters and/or string of numbers with alphabets and special characters. For e.g., the alphanumeric code may resemble one of 02345689, AABN01234, 098*(asterisk)908#(hash), AN03*p8#, or any other combination of alphabets, numbers, and special characters.

The instruction in accordance with aspects of this invention may be to open a web page or a URL. Where the execution of the instruction opens the webpage or the URL. The instruction may be to launch an application or software, where the execution of the instruction results in the launch of an application or software. The instruction may be to open a web browser, to open any URL of web or WAP portal, to send SMS or MMS or Network Messages, to request for USSD alerts, to download wallpapers/animations/themes or ringtones or full track music songs, to download Videos, open Video Calls or IVR or Video conferencing, download games, applications or software, and/or download any other content or services whether in text, image, sound, video or any other visible formats, opening a location based service, or opening location maps and travel routes, or opening a social network website, or a social network application.

In addition to executing instructions the instruction execution application 110, also communicates with the server 135 to download lists of restricted codes. Restricted codes are special alphanumeric codes that the network operators use to provide specific service to the network user; hence these codes cannot be used in or for any other application. The instruction execution application downloads the restricted code list during non-usage periods of the mobile device. Examples of such codes may be numbers reserved for emergency care like police, or ambulance services. or network operator specific services like customer care numbers.

To facilitate portability and/or compatibility among different devices and type of devices, the instruction execution application 110 can be implemented, for example, on a Java platform, a J2ME platform, a BREW platform, a Symbian operating system, a native operating system, Linux, a Pocket PC operating system, a Palm operating system, a Microsoft operating system, Samsung Bada, BrewMP, Nokia Qt, Nokia Symbian, i-mode, MTK, VRE, LiMO, Meego or any other mobile software platform.

The instruction execution application 110 can include software code defining the structure and other operations and features of the instruction execution application 110. The instruction execution application 110 may include the structure, other operations, and other features of the instruction execution application 110. The instruction execution application 110 may be stored in one or more separate files on the mobile device 105.

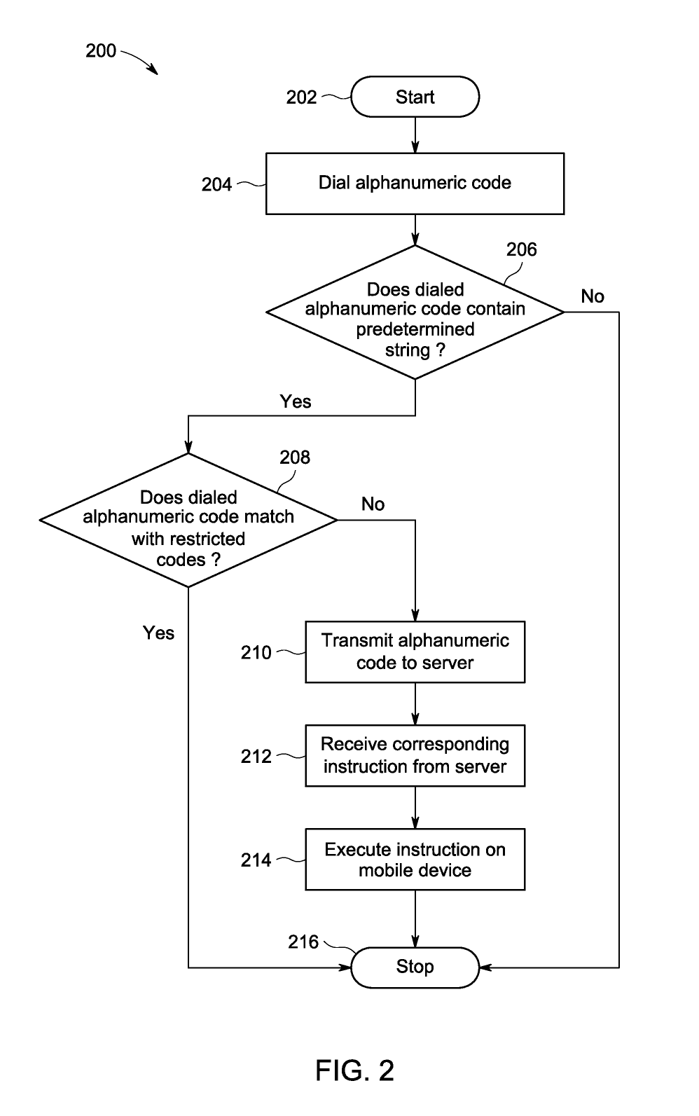

FIG. 2 is a flow diagram of a process 200 for executing an instruction on a mobile device. A user initiates the execution of the instruction or starts the process by dialing an alphanumeric code 204 on the mobile device 105. The dialing of the alphanumeric code may be by dialing numbers on a key pad, dialing by looking up in a phone book/contact list, dialing using a voice recognition system, dialing using motion based gestures, dialing by touch screen gestures, or by any other means known in the art. As described above, the alphanumeric code may be a string of numbers, string of numbers and alphabets, string of numbers with special characters and/or string of numbers with alphabets and special characters. For e.g., the alphanumeric code may be one of 02345689, AABN01234, 098*908#, AN03*p8#, or a combination thereof.

The instruction execution application 110 checks whether the alphanumeric code fulfills a predetermined condition 206. The predetermined condition may be a specific string of numbers, a specific string of alphabets, a specific string of special characters either preceding or succeeding the user input alphanumeric code, wherein the string may be a single element. If the predetermined string 206 is found in the alphanumeric code the instruction execution application 110 proceeds to the next step, else the instruction execution is stopped and a new instruction execution initiation is awaited by the instruction execution application 110.

If the predetermined string 206 is found then the instruction execution application 110 proceeds to check if the dialed alphanumeric code 204 is a restricted code 208. Restricted codes are special alphanumeric codes that the network operators use to provide specific service to the network user; hence these codes cannot be used in or for any other application. The instruction execution application 110 downloads the restricted code list during non-usage periods of the mobile device. Examples of such codes may be numbers reserved for emergency care like police, ambulance services, etc. or network operator specific services like customer care number etc.

If the dialed alphanumeric code 204 is not a restricted code the instruction execution application 110, proceeds to the next step, else the instruction execution is stopped and a new instruction execution initiation is awaited.

In the next step 210, the instruction execution application transmits the dialed alphanumeric code 204 to server 135. The transmitted alphanumeric code initiates a request for the corresponding instruction from the database 140 via the server 135. The server 135 compares the corresponding instruction from the database and transmits the instruction 212 back to the instruction execution application 110 on the mobile device.

After receiving the instruction 212 from the server 135, the instruction execution application 110 executes the instruction on the mobile device. An example of the instruction execution method is given below.

An example in accordance with the invention is given below. A user wishes to visit the URL http://www.google.com. The user looks up an alphanumeric code in the address book/contact list/phone book of the mobile device and initiates a call for the alphanumeric code corresponding to the URL http://www.google.com. For example, if the alphanumeric code is 1234567890. The predetermined string in this case is hash (#). Hence the corresponding alphanumeric code is #1234567890. The user dials #1234567890 on the mobile device. The instruction execution application 110 opens the URL http://www.google.com in the browser application of the mobile device.

The systems and all of the functional operations described in this specification can be implemented in digital electronic circuitry, or in computer software, firmware, or hardware, including the structural means disclosed in this specification and structural equivalents thereof, or in combinations of them. The techniques can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform the described functions by operating on input data and generating output. The processes and logic flows can also be performed by, and apparatus can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, aspects of the described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a web browser through which a user can interact with an implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described herein. Nevertheless, it will be understood that various modifications may be made. For example, operations of the logic flows depicted in FIG. 2 can be performed in a different order than that shown and/or can be performed iteratively. Accordingly, other implementations are within the scope of the following claims.

The embodiments described herein are examples of compositions, structures, systems and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed as being new and desired to be protected by Letters Patent of the United States is as follows:

1. A method for executing instructions on a mobile device, the method comprising the steps of:
dialing an alphanumeric code on a mobile device;
transmitting the alphanumeric code to a server;
requesting an instruction corresponding to the alphanumeric code from the server;
receiving the instruction corresponding to the alphanumeric code from the server; and
executing the instruction on the mobile device.

2. The method of claim 1, wherein the alphanumeric code comprises special characters.

3. The method of claim 2, wherein the special character comprises at least one of a hash (#), and an asterisk (*).

4. The method of claim 1, wherein the instruction is for opening a Universal Resource Link (URL) on the mobile device.

5. The method of claim 1, wherein the instruction is for launching a software application on the mobile device.

6. The method of claim 1 further comprising, after the step of dialing an alphanumeric code, the step of determining if the alphanumeric code fulfills a predetermined condition.

7. The method of claim 6, wherein the predetermined condition being at least one of a specific string of numbers, a specific string of alphabets, a specific string of special characters preceding the alphanumeric code, and a specific string of special characters succeeding the alphanumeric code.

8. The method of claim 7 further comprising, after the step of determining if the alphanumeric code fulfills a predetermined condition, the step of determining if the alphanumeric code is a restricted code by comparing the alphanumeric code to a restricted code list.

9. A system for executing instructions on a mobile device, the system comprising:
a database for storing an alphanumeric code mapped to an instruction;
a server for receiving the alphanumeric code and transmitting the mapped instruction stored on the database; and
a mobile device comprising;
a processor; and
a means for transmitting alphanumeric codes to the server, receiving instructions from the server, and executing the instruction.

10. The system of claim 9, wherein the means comprises a storage device storing a client application operable to transmit the alphanumeric codes to the server, receive instructions from the server, and execute the instructions.

11. The system of claim 9, wherein the alphanumeric code comprises special characters like hash (#), and asterisk (*).

12. The system of claim 9, wherein the instruction is for opening a Universal Resource Link (URL) on the mobile device.

13. The system of claim 9, wherein the instruction is for launching a software application on the mobile device.

14. An instruction execution application, the instruction execution application configured for:
checking an alphanumeric code dialed on a mobile device for presence of at least one special character;
transmitting the alphanumeric code to a server;
receiving at least one instruction corresponding to the alphanumeric code from the server; and
executing the instruction on the mobile device.

15. The instruction execution application of claim 11, wherein the special character comprises at least one of a hash (#), and an asterisk (*).

16. The instruction execution application of claim 11, wherein the instruction is for opening a Universal Resource Link (URL) on the mobile device.

17. The instruction execution application of claim 11, wherein the instruction is for launching a software application on the mobile device.

18. The instruction execution application of claim 11, wherein the instruction execution application is implemented in Java.

19. The instruction execution application of claim 11, wherein the instruction execution application is implemented in Binary Runtime Environment for Wireless.

20. The instruction execution application of claim 11, wherein the instruction execution application is stored in the mobile device.
